(19) United States
(12) Patent Application Publication
(10) Pub. No.: US 2024/0307964 A1
(43) Pub. Date: Sep. 19, 2024

(54) FOAM-FILLED NODES

(71) Applicant: Divergent Technologies, Inc., Los Angeles, CA (US)

(72) Inventors: Bahram ISSARI, Laguna Niguel, CA (US); Michael Thomas Kenworthy, Rancho Palos Verdes, CA (US); Liaowang Liu, Long Beach, CA (US); Loan Chanh Le, Anaheim, CA (US); Seyedalireza Torbatisarraf, Los Angeles, CA (US)

(21) Appl. No.: 18/603,387

(22) Filed: Mar. 13, 2024

Related U.S. Application Data
(60) Provisional application No. 63/452,087, filed on Mar. 14, 2023.

(51) Int. Cl. B22F 10/28; B33Y 10/00; B33Y 40/20; B33Y 80/00; C23C 24/04

(52) U.S. Cl. CPC B22F 10/28; B33Y 10/00; B33Y 40/20; B33Y 80/00; C23C 24/04; B22F 2998/10

(57) ABSTRACT

Techniques for injecting adhesive materials are presented herein. An apparatus in accordance with an aspect of the present disclosure comprises an additively manufactured hollow node having a surface opening, and adhesive material extending from the surface opening into an internal volume of the additively manufactured hollow node. The adhesive material comprises a foaming adhesive. Another method may include preparing at least one undercut region on a surface to accept a cold spray deposition, performing a first cold spray process to deposit material into the at least one undercut region for reducing corrosion on a metallic interface formed at the surface; and performing a second cold spray process to build the metallic interface for joining an aluminum component.

### CROSS-REFERENCE TO RELATED APPLICATIONS

This application claims priority to U.S. Provisional Application No. 63/452,087 titled “FOAM-FILLED NODES,” filed Mar. 14, 2023, which is assigned to the assignee hereof, and incorporated herein by reference in its entirety as if fully set forth herein.

### BACKGROUND

### Field

The present disclosure relates generally to apparatuses and methods for printing a hollow node having a surface opening, and more specifically to injecting adhesive material into an internal volume of the hollow node.

### Background

Additive Manufacturing (AM) processes involve the layer-by-layer buildup of one or more materials to make a three-dimensional (3-D) object. AM techniques are capable of fabricating complex components from a variety of materials. Typically, a freestanding object is fabricated from a computer aided design (CAD) model. Using the CAD model, the AM process can create a solid or hollow 3-D object by using a laser beam to sinter or melt a powder material, which then bonds the powder particles together. In the AM process, different materials or a combinations of materials, such as engineering plastics, thermoplastic elastomers, metals, and ceramics may be used to create a uniquely shaped 3-D object.

Hollow 3-D printed nodes may have surface openings designed to allow removal of internally trapped materials such as metal powder and/or broken support material, which may be artifacts of the printing process. Not only can materials be removed from the internal sections of the 3-D printed parts, but materials can also enter the hollow sections of 3-D printed parts. Entry of material and chemicals into the 3-D printed parts may be beneficial in situations where chemicals may cause treatment and/or coating of internal surfaces to improve corrosion resistance. This may lead to circumstances where solids, liquids, and devices may be intentionally placed within the surface openings.

However, entry of material into the 3-D printed nodes also has the potential to negatively impact the system. For example, ingress and entrapment of surface treatment chemicals into the cavities may impact properties of the 3-D printed nodes. There may also be a possibility of contamination of bonding surfaces by slow leakage of the trapped materials to outside surfaces. In addition, surface openings may expose the internal surfaces of 3-D printed parts to elements causing degradation of properties.

### SUMMARY

Several aspects of techniques for injecting adhesive material into an internal volume of additively manufactured structures will be described more fully hereinafter with reference to 3-D printing techniques.

A structure in accordance with an aspect of the present disclosure comprises an additively manufactured (AM) hollow node having a surface opening, and adhesive material extending from the surface opening into an integral volume of the additively manufactured hollow node.

A method in accordance with an aspect of the present disclosure comprises printing a hollow node having a surface opening by additive manufacturing, and injecting adhesive material into an internal volume of the hollow node via the surface opening.

A method in accordance with an aspect of the present disclosure comprises preparing at least one undercut region on a surface to accept a cold spray deposition, performing a first cold spray process to deposit material into the at least one undercut region for reducing corrosion on a metallic interface formed at the surface, and performing a second cold spray process to build the metallic interface for joining an aluminum component.

It will be understood that other aspects of joining nodes and subcomponents with adhesive will become readily apparent to those skilled in the art from the following detailed description, wherein it is shown and described only several embodiments by way of illustration. As will be appreciated by those skilled in the art, the joining of additively manufactured nodes and subcomponents can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatuses and methods for joining nodes and subcomponents with adhesive will now be presented in the detailed description by way of example, and not by way of limitation, in the accompanying drawings, wherein:

FIGS. 1A-1D illustrate respective side views of a 3-D printer system in accordance with an aspect of the present disclosure:

FIG. 1E illustrates a functional block diagram of a 3-D printer system in accordance with an aspect of the present disclosure:

FIG. 2 illustrates an example of an additively manufactured hollow node in accordance with an aspect of the present disclosure:

FIGS. 3A-3D illustrate a process of repairing damaged structures through a crack or opening using cold spray in accordance with an aspect of the present disclosure:

FIGS. 4A-4D illustrate a process of repairing damaged structures through a crack or opening using cold spray in accordance with an aspect of the present disclosure:

FIG. 5 is a flowchart illustrating an example method in accordance with the systems and methods described herein:

FIG. 6 is a flowchart illustrating an example of applying a consumable surface coating in accordance with the systems and methods described herein:

FIG. 7 is a flowchart illustrating an example of applying a consumable surface coating in accordance with the systems and methods described herein:

FIG. 8 is a flowchart illustrating an example of applying a consumable surface coating to protect the composite substrate during an initial layer deposition in accordance with the systems and methods described herein:

FIG. 9 is a flowchart illustrating an example of utilizing an area heater and carefully optimized cold spray parameters (e.g., nozzle geometry, stand-off distance, feedstock material, carrier gas temperature and pressure) on a hybrid system to soften the substrate during cold spray deposition in accordance with the systems and methods described herein:

FIG. 10 is a flowchart illustrating an example of depositing a granular material to the surface of the thermoset during curing in accordance with the systems and methods described herein:

FIG. 11 is a flowchart illustrating an example of utilizing high temperature thermoplastics and thermosets reinforced with Kevlar fibers in accordance with the systems and methods described herein:

FIGS. 12A-12D illustrate a cross sectional cut of a cold spray composite joining overview in accordance with the systems and methods described herein:

FIG. 13 shows an example of a cold spray head mount equipped with heat source and laser in accordance with the systems and methods described herein:

FIGS. 14A-B illustrate a closed loop powder collection system in accordance with the systems and methods described herein:

FIG. 15 is a flowchart illustrating an example of applying cold spray deposition in accordance with the systems and methods described herein:

FIG. 16 is a flowchart illustrating an example of applying cold spray deposition in accordance with the systems and methods described herein:

FIG. 17 is a flowchart illustrating an example of applying cold spray deposition in accordance with the systems and methods described herein; and

FIG. 18 is a flowchart illustrating an example of applying cold spray deposition in accordance with the systems and methods described herein.

### DETAILED DESCRIPTION

The detailed description set forth below in connection with the drawings is intended to provide a description of exemplary embodiments of joining additively manufactured nodes and subcomponents, and it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of additive manufacturing in the context of joining two or more parts provides significant flexibility and cost saving benefits that enable manufacturers of mechanical structures and mechanized assemblies to manufacture parts with complex geometries at a lower cost to the consumer. The joining techniques described in the foregoing relate to a process for connecting AM parts and/or commercial off the shelf (COTS) components. AM parts are printed three-dimensional (3-D) parts that are printed by adding layer upon layer of a material based on a preprogramed design. The parts described in the foregoing may be parts used to assemble a transport structure such as an automobile. However, those skilled in the art will appreciate that the manufactured parts may be used to assemble other complex mechanical products such as vehicles, trucks, trains, motorcycles, boats, aircraft, and the like, and other mechanized assemblies, without departing from the scope of the invention.

In one aspect of the disclosure, a joining technique for additively manufactured nodes is disclosed. A node is an example of an AM part. A node may be any 3-D printed part that includes a socket or other mechanism (e.g., a feature to accept these parts) for accepting a component such as a tube and/or a panel. The node may have internal features configured to accept a particular type of component. Alternatively or conjunctively, the node may be shaped to accept a particular type of component. A node, in some embodiments of this disclosure may have internal features for positioning a component in the node's socket. However, as a person having ordinary skill in the art will appreciate, a node may utilize any feature comprising a variety of geometries to accept any variety of components without departing from the scope of the disclosure. For example, certain nodes may include simple insets, grooves or indentations for accepting other structures, which may be further bound via adhesives, fasteners or other mechanisms.

Nodes as described herein may further include structures for joining tubes, panels, and other components for use in a transport structure or other mechanical assembly. For example, nodes may include joints that may act as an intersecting points for two or more panels, connecting tubes, or other structures. To this end, the nodes may be configured with apertures or insets configured to receive such other structures such that the structures are fit securely at the node. Nodes may join connecting tubes to form a space frame vehicle chassis. Nodes may also be used to join internal or external panels and other structures. In many cases, individual nodes may need to be joined together to accomplish their intended objectives in enabling construction of the above described structures. Various such joining techniques are described below.

The present disclosure is directed to injecting adhesive material to close (e.g., seal) a surface opening, attach embed devices, hold various structures in place, and/or add structural integrity. In an aspect of the present disclosure, the adhesive material may be a foaming adhesive. In an aspect of the present disclosure, the apparatus may have a support structure for further processing to be carried out in the internal volume.

The adhesive material may, in some aspects, be used to couple an additionally additively manufactured part to an outer surface of the hollow node. In other aspects of the present disclosure, the hollow node may include a printed distributed system matrix including at least an internal channel and a port to spatially distribute the adhesive material. In some aspects, the adhesive material may be used to couple an embedded part to an internal surface of the additively manufactured hollow node. The disclosure covers the use of an adhesive material to bond the parts, including conventional adhesives, foaming adhesives, non-foaming adhesives, and also including sealants or other materials that may have adhesive properties.

Methods for attaching hollow objects to other hollow pieces or non-hollow pieces involve mating of some segments of external surfaces by application of adhesives. welding, riveting, etc. More specifically, the surface of one object, most commonly at the extremity of the parts being attached, may sit on top of the surface of the other part. The two surfaces may then be attached by various means such as mechanical, welded, or bonded using adhesives. In some examples, the adhesives may be placed between the two surfaces or applied on the outside of the mated surfaces. The outside surface application may be carried out using liquid, gel adhesives, tapes, or any other suitable method. Joint geometries such as a tongue-and-groove joint may be used such that the adhesive is applied to the joining surfaces prior to mating. For instance, adhesives may also be applied to tongue-and-groove joints in combination with application of adhesive on both external surfaces.

In some cases, one external surface may be inaccessible. For instance, hollow objects may be difficult to bond from internal surfaces. In some examples, the internal volume of mating objects, especially with complex internal geometries, can be filled with adhesive, which is then cured to afford a rigid, internally bonded matrix. However, this method may suffer from stresses generated by shrinkage of the larger volume of adhesive, as well as potential hot spots during curing of adhesives. Another potential drawback to this method may be the added weight of adhesive filled volumes, which may be detrimental to use of hollow objects to reduce the weight of assemblies. In addition, the other external surface may simply not be available for bonding due to other considerations such as painting or general aesthetics.

The disclosure described herein may involve using foaming adhesives, non-foaming adhesives, or foamed matrices to cure rigid structures. These structures may have the benefits of required properties such as rigidity, toughness, temperature resistance, chemical resistance.

The method may involve applying adhesives as a small volume of liquid to locations within internal structures of the hollow objects with use of designed “straws.” After placement or during a curing stage, the liquid may expand many times its volume to fill the gaps and spaces within the hollow objects.

Hollow objects that are bonded together via other mechanisms such as a tongue-and-groove or mechanical fastening are further reinforced by application of internal bonding of the joint areas as well as the stability afforded through the bulk of the internal matrix to the overall bond line and structure. In addition, the internally bonded joints using adhesive foam may be sufficient to meet property requirements of the assembled hollow objects with no requirements for other procedures.

### Additive Manufacturing Environment.

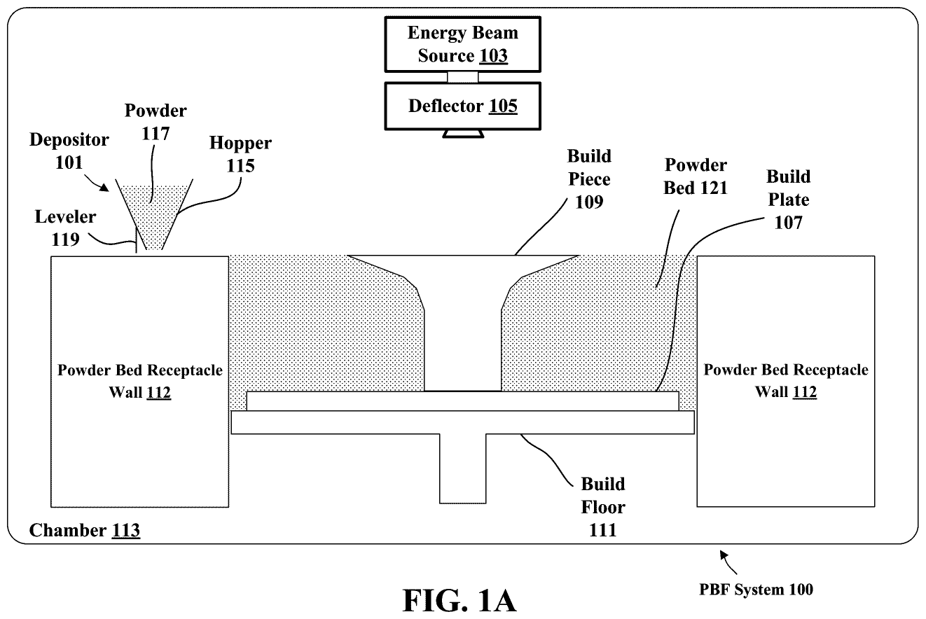

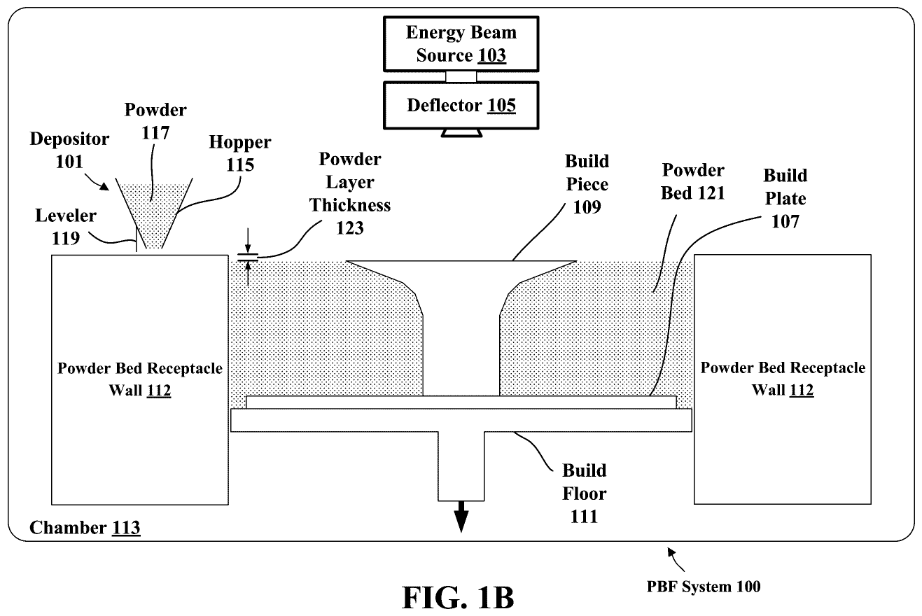

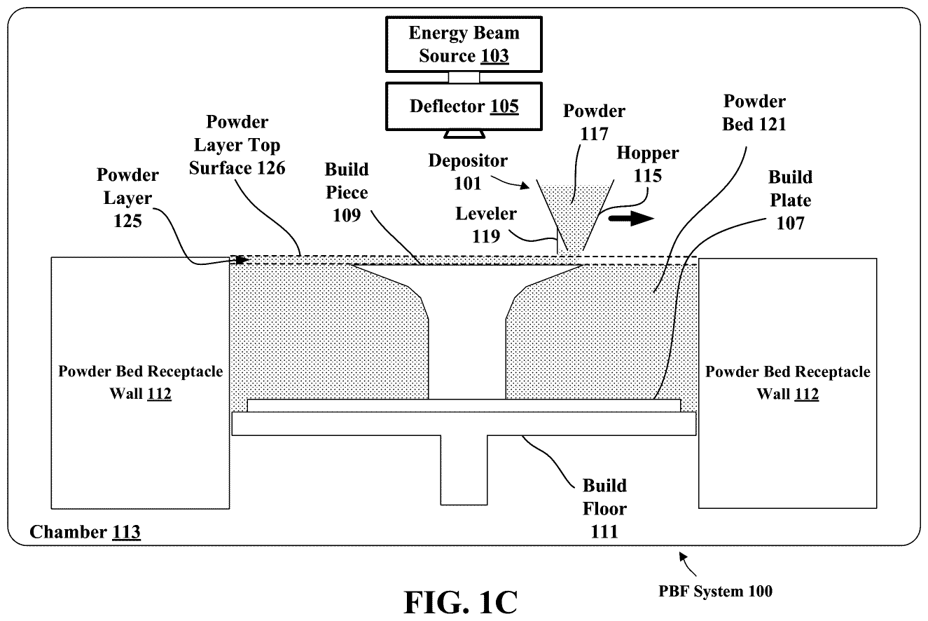

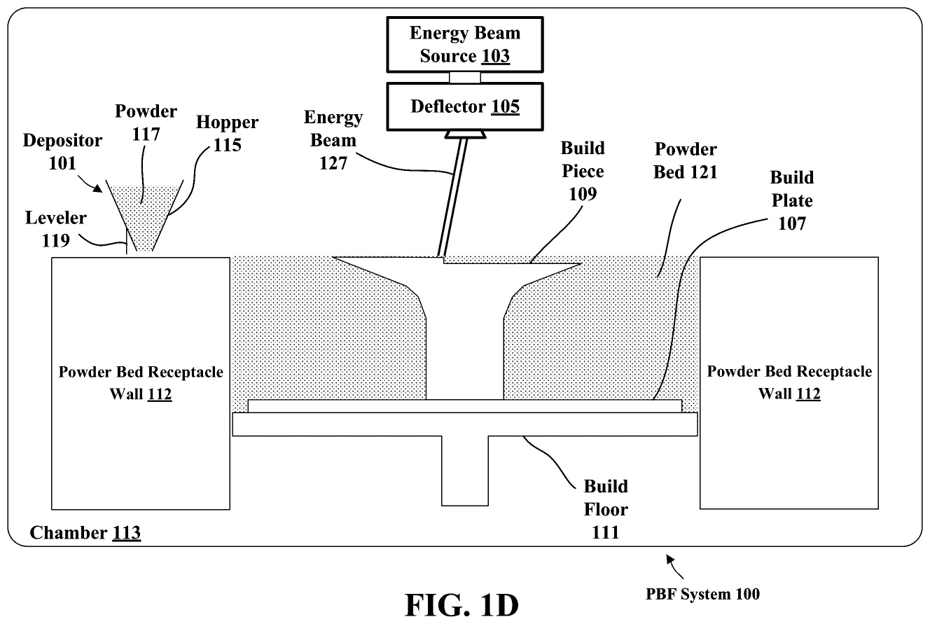

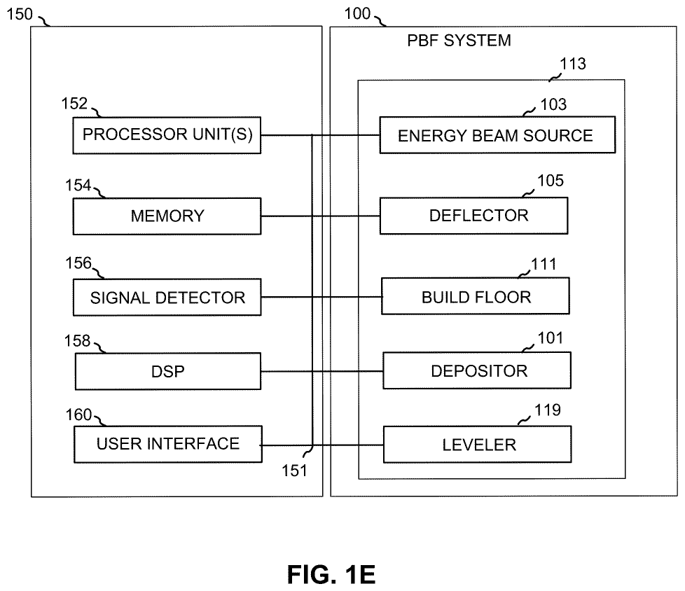

FIGS. 1A-D illustrate respective side views of an exemplary 3-D printer system in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor unit 152, memory 154, signal detector 156, a digital signal processor (DSP) 158, and one or more user interfaces 160. Computer 150 may include additional components without departing from the scope of the present disclosure.

The computer 150 may include at least one processor unit 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor 504. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may comprise a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

One example of 3-D printing may use cold spray forming as part of a manufacturing process of components. Spray forming may direct a solid phase powder material into a base material at high speed. Cold spray forming may generally be an additive manufacturing process by spraying one or more materials to form a manufactured article. With the cold spray manufacturing process, a material being deposited may be kept well below the material's melting point. The material being deposited may be sprayed at a base material at a speed high enough to induce solid-state welding on impact. The material may be sprayed using a nozzle. Cold spray may be used to deposit a metal (or metal alloy, plastics, ceramics, or mixtures thereof) structure to join, for example, a number of off-the-shelf parts or manufactured parts such as extruded parts, 3-D printed parts, cold spray 3-D printed parts or other manufactured parts. Cold spray is known to also work on composite, thermoplastic, or thermoset surfaces.

Cold spray may be utilized to repair damages to 3D printed and hollow parts. These 3D printed and hollow structures or parts may be damaged or defective based on issues encountered during printing, post processing, or handling. In addition, it is possible that parts utilized in the field may also be damaged, broken, or cracked.

However, cold spray of damaged hollow structures may require placement of a support structure within the crack or opening to allow for the coating of the cold spray. Embodiments in this disclosure describe the use of foaming liquids that may be inserted within the spaces of the hollow object. Accordingly, the foaming liquid may turn into a foamed solid which fills up the cavity. In some examples, the foaming liquid may be an adhesive capable of being bonded to the surfaces within the structure.

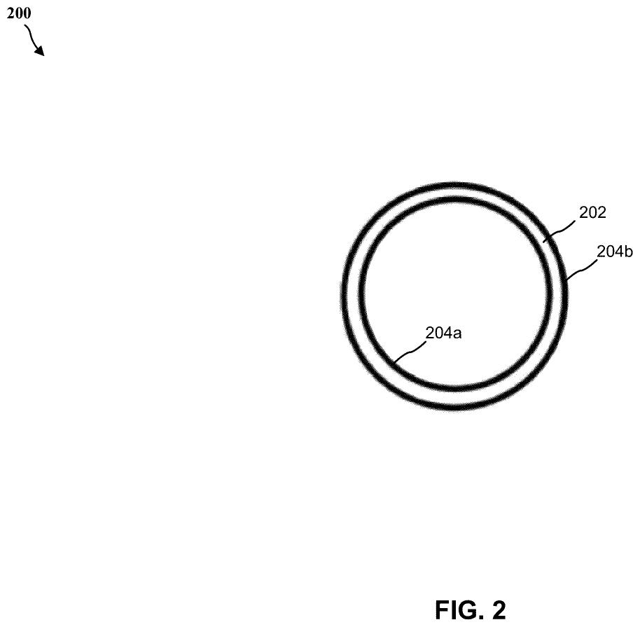

Turning now to FIG. 2, there is a cross-sectional view of a hollow object showing an inner and outer wall.

In the example 200 of FIG. 2, a hollow object 202 showing an inner 204a and outer wall 204b is illustrated. Specifically, example 200 shows a cross-sectional view of a hollow object 202 having both an inner wall 204a and an outer wall 204b.

These hollow 3D printed objects may have surface openings designed to allow for removal of internally trapped materials such as metal powder and broken support material, which are artifacts of the printing process. These openings have both benefits and draw backs. For example, even though materials may be removed from internal sections of the 3D printed parts, materials may also enter the hollow sections of the 3D printed parts. Accordingly, entry of material and chemicals into the hollow sections of the 3D printed parts may be beneficial when the materials and chemicals cause treatment and/or coating of internal surfaces to improve corrosion resistance against the elements. Thus, solids, liquids and devices may be placed intentionally into the hollow sections of the 3D printed parts through the openings.

However, entry of materials into the 3D printed internal spaces may also have potential to negatively impact the system. An example would entail ingress and entrapment of surface treatment chemicals into the cavities since entrapped materials may impact properties of the 3D printed part. In addition, there is also a potential for contamination of bonded surfaces via slow leakage of trapped material to the outside surfaces. Furthermore, the openings may expose internal surfaces of the 3D printed parts to the elements causing degradation of properties.

### Using Adhesive as Primary Joining Method

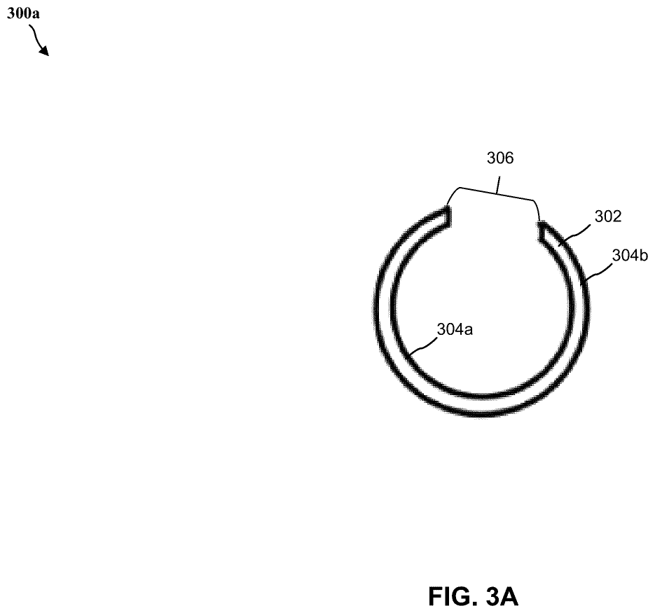

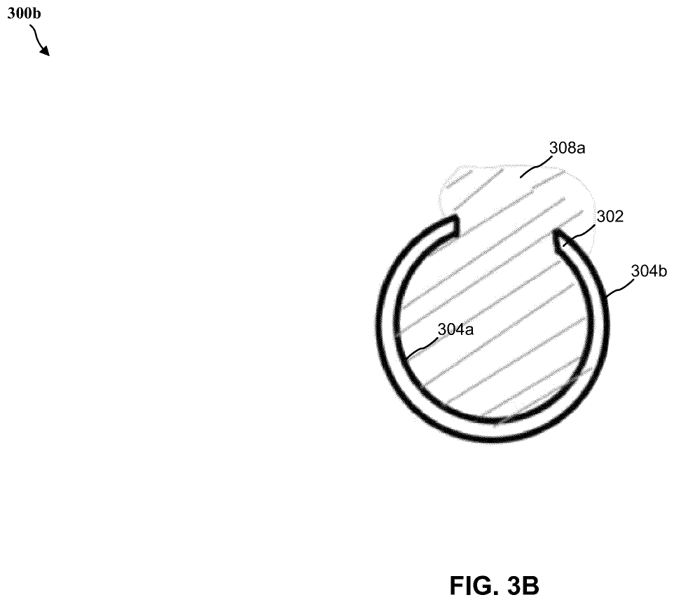

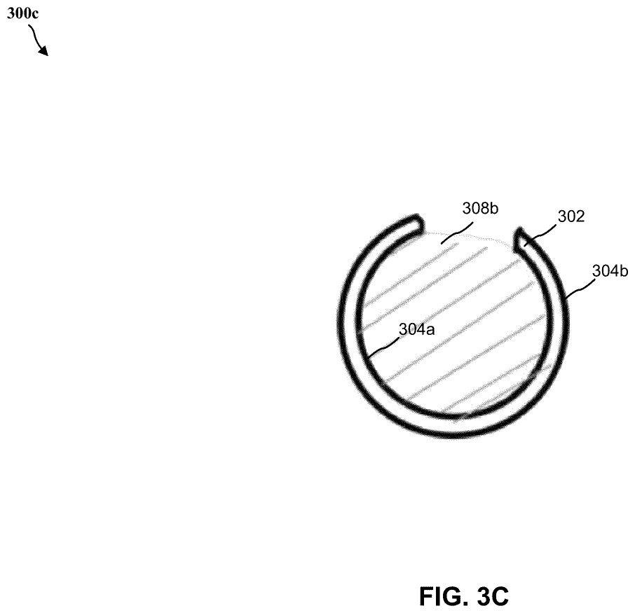

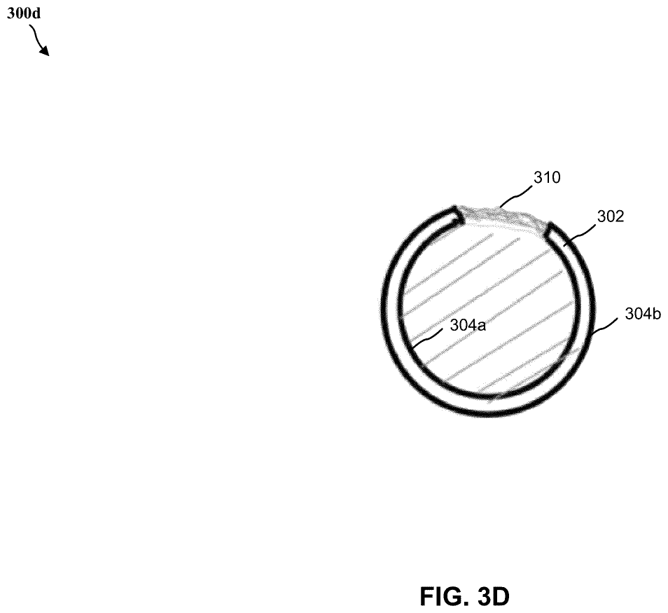

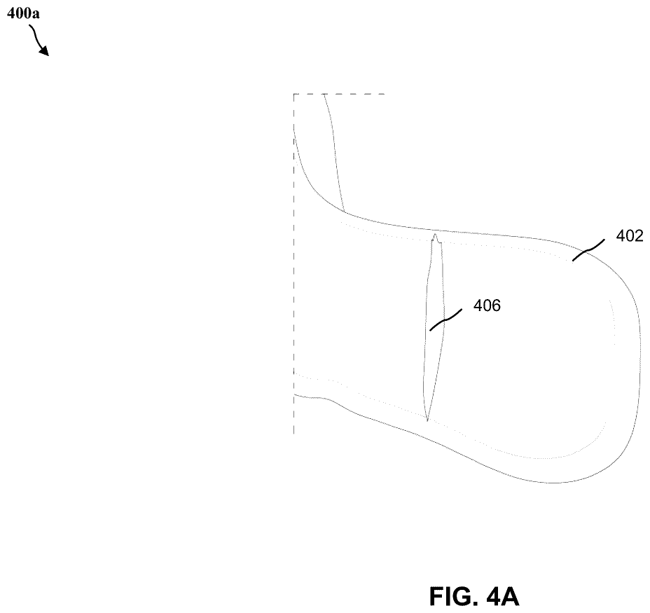

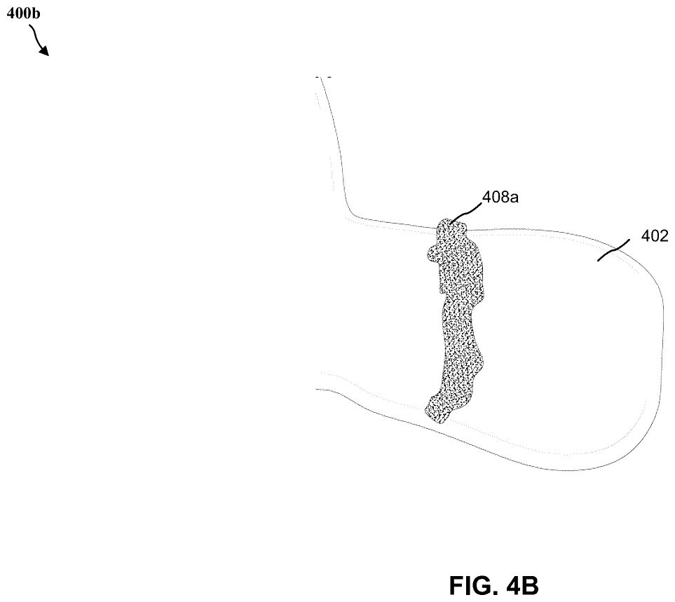

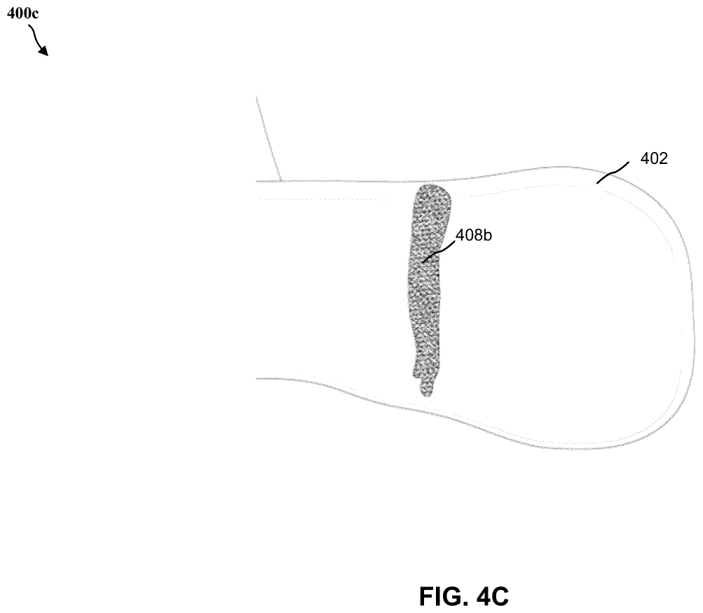

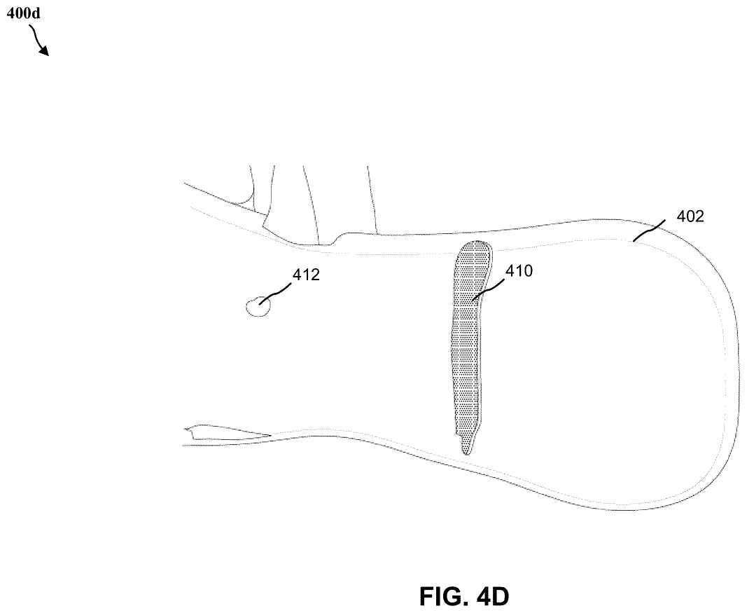

As will be described below in FIGS. 3A-3D and 4A-4D, an improvement to fix the surface openings or cracks on hollow 3D-printed objects includes using adhesives to close the openings after removing internally trapped materials with minimal impact on the weight of the object. In some examples, the adhesives may be foaming adhesives or liquid adhesives. Adhesive incorporation may also close an opening with minimal effect on aesthetics of the printed parts. In addition, the adhesives may also be used to adhere and/or support other objects (e.g., electronic devices or sensors) within the open space of the 3D printed parts. Closure of the openings may help protect the inner parts of the 3D printed parts from exposure to outside elements.

In some examples, adhesives may also provide other beneficial properties such as being fire retardant. Other beneficial impacts of the internally dispersed foam may be to spread the impact of forces in a more desirable manner and to help improve performance properties of the printed parts as compared to other similar methods. Another application of applying foam within the hollow parts may be to wall off or segment internal volumes of the 3D printed parts.

Another method for the ingress of surface treatment chemicals into an inner space of 3D printed parts may be to print parts with no openings. Instead, the 3D printed parts may have thin wall enclosures enclosing the openings. The walls may then be removed by post processing of the 3D printed parts after surface treatment process is completed. This process ensures no contamination of inner surfaces by chemicals. However, a drawback to this process is that internally trapped material may need to be removed after opening of the walls. This may require an additional post process step and may contaminate the bonding surfaces.

Yet another method may include masking part openings using tape that would survive a surface treatment process. Thus, once the surface treatment process is completed, the tapes may either be removed or left on the parts.

FIGS. 3A-3D illustrate a process of repairing damaged structures through a crack or opening using cold spray. Specifically, the foamed solid may be machined to provide an inset into the opening such that the repaired surface will be continuous with surrounding areas after completion of cold spray. These repairs may improve the life of 3D printed objects and structures.

FIG. 3A shows an example 300a of a hollow object 302 with damage causing a broken opening 306 in both the inner wall 304a and outer wall 304b. Specifically, the hollow object 302 has a broken opening 306 that creates a hole through both the outer wall 304b and the inner wall 304a. In some examples, the crack or damaged area may be opened further to provide a more viable opening to be repaired.

FIG. 4A shows an example 400a of a different perspective of a hollow object 402 with damage causing an opening 406 through an outer wall and inner wall. Specifically, example 400a shows a top view of a hollow object 402 having an opening 406 through both an inner wall and an outer wall.

FIG. 3B shows an example 300b of the hollow object 302 with foam filling the inside. Specifically, example 300b shows a cross-sectional view of the hollow object 302 from FIG. 3A. The foamed material 308a may extrude through the broken opening 306 and solidify around and over portions of the outer wall 304b. Once the foamed material 308a is solidified then it may be machined to the shape required for cold spray. In some examples, the foamed material does not have to fill the object completely since it may be sufficient for the area close to the opening (e.g., damaged portion) to be enclosed by the foam.

FIG. 4B shows an example 400b of a different perspective of the hollow object 402 with foamed material 408a extruding through the broken opening. Specifically, example 400b shows a top view of the hollow object 402 having foamed material 308a solidifying over a broken opening.

In some examples, the adhesive may foam immediately during application or be timed to foam in a manner for proper penetration of liquid adhesive into the 3D printed part prior to initiation of foaming.

FIG. 3C shows an example 300c of a hollow object 302 with foam machined to desired shape. Specifically, example 300b shows a cross-sectional view of the hollow object 302 from FIG. 3B. The foamed material is machined to a desired shape 308b such that the repaired surface may be continuous with surrounding areas of the object.

FIG. 4C shows an example 400c of a different perspective of the hollow object 402 where the foamed material is machined to a desired shape 408b such that the repaired surface is continuous with surrounding areas of the object. Specifically, example 400c shows a top view of the hollow object 402.

FIG. 3D shows an example 300d of a hollow object 302 with foam enclosed with dry spray 310. Specifically, example 300b shows a cross-sectional view of the hollow object 302 from FIG. 3C. Here, the foamed surface may be sufficiently resistant to cold spray to act without need of further surface treatment. In some examples, a thin treatment of the foam surface may be required to allow for optimum cold spray surfacing.

In some examples, the foaming liquid is inserted close to the damaged area through a hole (e.g., machined hole 412 shown in FIG. 4D) that is machined in to the 3D printed object. The hole is machined on the hollow object proximate to the damaged area to allow injection of the foaming liquid into the internal space allowing the foam to fill the damaged section.

FIG. 4D shows an example 400d of a different perspective of the hollow object 402 with foam enclosed with dry spray. Specifically, example 400d shows a top view of the hollow object 402. Here, example 400d shows a machined hole 412 that is intentionally machined in to the hollow object 402 to allow injection of a foaming liquid into the internal space. In some examples, the machined hole that is machined into the hollow object 402 allows a foaming liquid to be inserted close to a damaged area through.

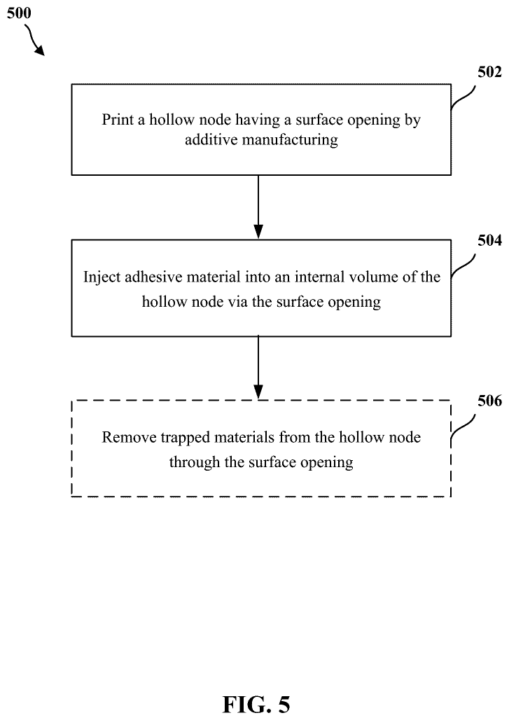

FIG. 5 illustrates a process in accordance with an aspect of the present disclosure.

FIG. 5 is a flowchart 500 illustrating an exemplary process for printing an AM structure in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 502, the method 500 may include printing a hollow node having a surface opening by additive manufacturing. As an example, referring back to FIG. 4D, a machined hole 412 is machined into the hollow object 402. The surface openings may be intentional openings used to remove or inject parts. As an example, during 3-D printing, material such as powders or supports may need to be removed. The surface openings allow for the removal of those materials.

At block 505, the method 500 may include injecting adhesive material into an internal volume of the hollow node via the surface opening. In some examples, the adhesive material may comprise a foaming adhesive. Advantages to using foam adhesive may be that the foam adhesive fills out an inner space more efficiently due to generating its own volume and not adding much to the overall weight. As an example, referring back to FIG. 3B, the hollow object 302 may be filled with foamed material 308a that is a foaming adhesive. As another example, referring back to FIG. 4B, the hollow object 402 may be filled with foamed material 408a that is a foaming adhesive.

In some examples, the adhesive material may comprise a non-foaming adhesive. In some examples, the adhesive material may be a liquid adhesive, which is stronger than a foaming adhesive.

In some examples, the hollow node may comprise a printed distributed system matrix comprising at least an internal channel and a port to spatially distribute the adhesive material. In some examples, the internal channel and the port may be filled with the adhesive material to segment internal volumes of the hollow node. For example, internal channels and ports within the printed lattice and/or ribs may “seed” the reactions and spatially distribute the foaming adhesive more evenly within the intended volume to be filled. Thus, the matrix may also act as a dual-purpose stiffener to meet dynamic stiffness targets of the overall structure.

Optionally, at block 506, the method 500 may include removing trapped materials from the hollow node through the surface opening.

It is understood that the method illustrated by FIG. 5 is exemplary in nature and that the steps described herein may be combined or modified to generate alternative embodiments.

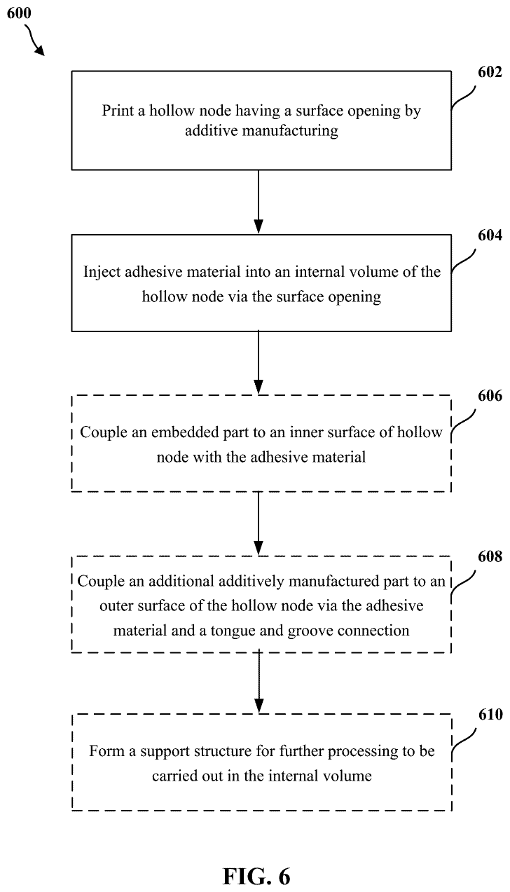

FIG. 6 illustrates a process in accordance with an aspect of the present disclosure.

FIG. 6 is a flowchart 600 illustrating an exemplary process for printing an AM structure in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 602, the method 600 may include printing a hollow node having a surface opening by additive manufacturing.

At block 604, the method 600 may include injecting adhesive material into an internal volume of the hollow node via the surface opening. As an example, referring back to FIG. 3B, the foamed material 308a is injected into the internal volume of the hollow object 302 via a surface opening. As another example, referring back to FIG. 4B, the foamed material 408a is injected into the internal volume of the hollow object 402 via a surface opening.

In some examples, the adhesive material may comprise a foaming adhesive. As an example, referring back to FIG. 3B, the hollow object 302 may be filled with foamed material 308a that is a foaming adhesive. As another example, referring back to FIG. 4B, the hollow object 402 may be filled with foamed material 408a that is a foaming adhesive. In some examples, the adhesive material may comprise a non-foaming adhesive.

Optionally, at block 606, the method 600 may include coupling an embedded part to an inner surface of hollow node with the adhesive material. For example, the embedded part may be an accelerometer that is coupled to the inner surface of the hollow node with the adhesive material.

Optionally, at block 608, the method 600 may include coupling an additional additively manufactured part to an outer surface of the hollow node via the adhesive material and a tongue and groove connection. In some examples, the adhesive material may be continuous with the outer surface of the hollow node. As an example, referring back to FIG. 3C, the foamed material is machined to a desired shape 308b such that the adhesive material is continuous with the outer surface of the hollow object 302. As another example, referring back to FIG. 4C, the foamed material is machined to a desired shape 408b such that the adhesive material is continuous with the outer surface of the hollow object 402.

In some examples, the adhesive material may extend past the surface opening of the hollow node. As an example, referring back to FIG. 3B, the foamed material 308a extends past the surface opening of the hollow object 302. As another example, referring back to FIG. 4B, the foamed material 408a extends past the surface opening of the hollow object 402.

Optionally, at block 610, the method 600 may include forming a support structure for further processing to be carried out in the internal volume. In some examples, by a proper design of the internal bonding section, a volume fill of the internal adhesive may be minimized as to the volume required to bond the joints through internal surfaces. In some examples, the support structure may comprise a cold spray material. In some examples, the cold spray material may comprise a ductile aluminum alloy on an outer surface of the hollow node to create a metallic surface.

It is understood that the method illustrated by FIG. 6 is exemplary in nature and that the steps described herein may be combined or modified to generate alternative embodiments.

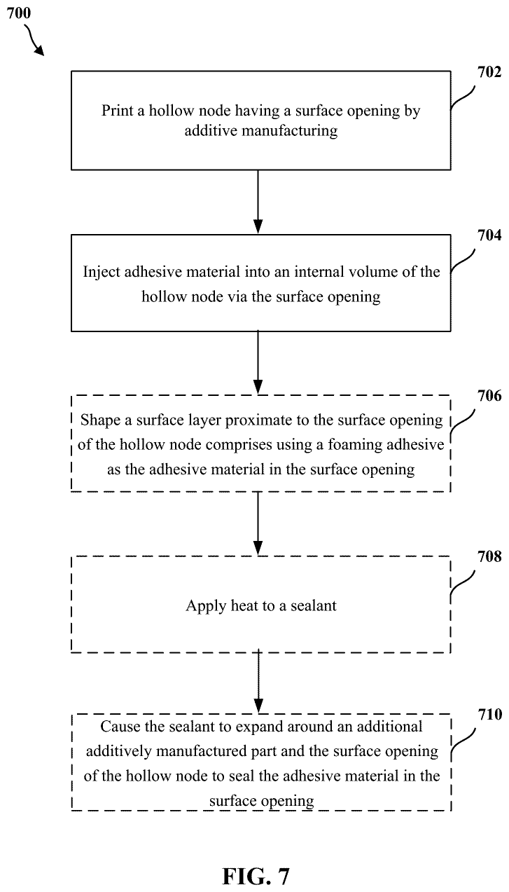

FIG. 7 is a flowchart 700 illustrating an exemplary process for printing an AM structure in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 702, the method 700 may include printing a hollow node having a surface opening by additive manufacturing. As an example, referring back to FIG. 4D, a machined hole 412 may be intentionally machined into a hollow object 402.

At block 704, the method 700 may include injecting adhesive material into an internal volume of the hollow node via the surface opening.

Optionally, at block 706, the method 700 may include shaping a surface layer proximate to the surface opening of the hollow node comprises using a foaming adhesive as the adhesive material in the surface opening.

Optionally, at block 708, the method 700 may include applying heat to a sealant.

Optionally, at block 710, the method 700 may include causing the sealant to expand around an additional additively manufactured part and the surface opening of the hollow node to seal the adhesive material in the surface opening.

It is understood that the method illustrated by FIG. 7 is exemplary in nature and that the steps described herein may be combined or modified to generate alternative embodiments.

### Using Cold Spray as Primary Joining Method

Metallization of plastic molds is a known process, but this process does not result in desired mechanical properties. Depending on the application, the plastic component may be left in or removed by various methods.

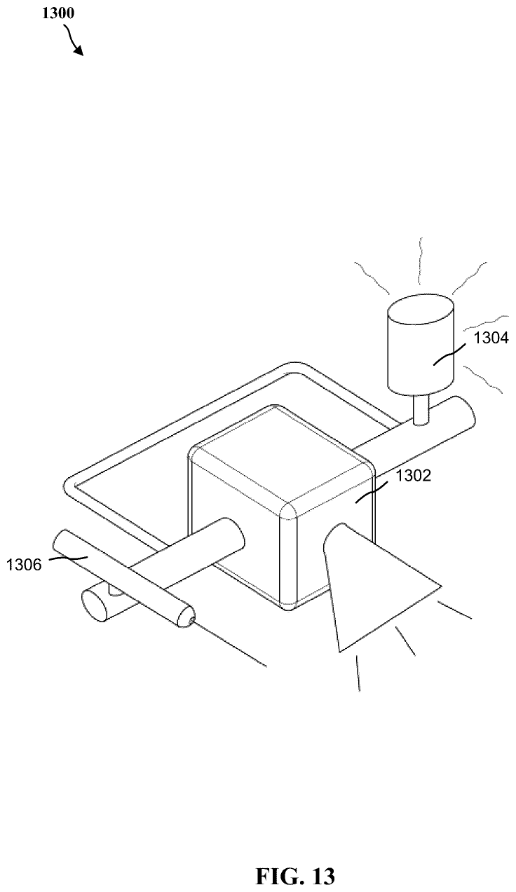

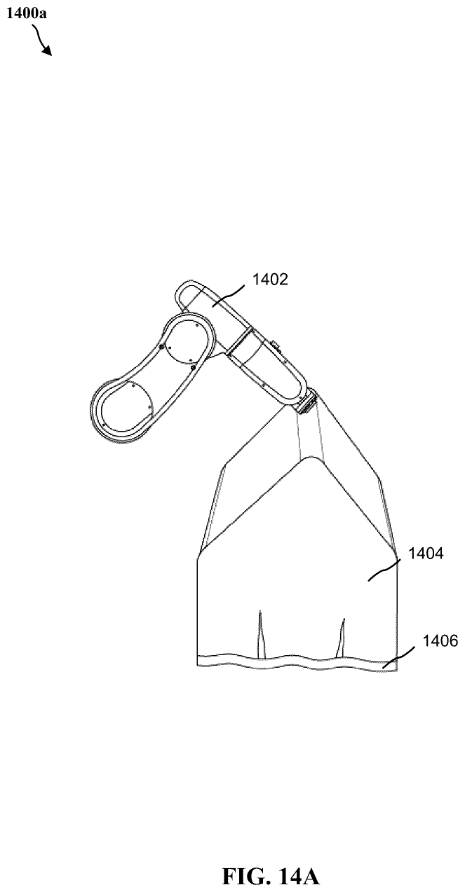

In order to alleviate the draw backs of the metallization of plastic molds, the method may include obtaining a functional component with desirable mechanical properties via severe plastic deformation (e.g., cold spray). In some examples, the processing parameters may be tuned as the initial layers are being applied such that a softer plastic substrate may survive the particle impacts without the surface being ablated or eroded. As will be shown in FIG. 13, a laser mounted to a cold spray head may be configured to measure standoff distance measurements and also control various spray parameters. This allows the particles to be delivered at a lower impact velocity and, ideally, become embedded in the surface of a polymer. Once, a sufficiently tough metal base layer is established, then the operational mode of the system would shift to apply a high pressure velocity to ensure necessary levels of particle deformation to achieve desired mechanical properties. Specifically, the method may include a transition from the low pressure cold spray to high pressure cold spray regime during a build-up of the hybrid object. In some examples, any logical gradient between the low pressure and high pressure extremes may be controlled and combined with the tool pathing. Once the desired build-up is complete, the lower pressure mode may be re-engaged to improve surface finish quality for a resultant near net shape object.

The proposed process may incorporate other metallization or deposition processes such as plating. There may also be other opportunities to implement a multi-material structure (e.g., different metal deposits in different regions) and define gradients and transitions within a given deposit region. For example, use of a low velocity of deposition substrate such as zinc for initial layers if the underlying polymer substrate is relatively less tough or resilient to the low pressure cold spray. As a non-limiting example, a transition from aluminum as a primary structural deposit to a finishing layer of nickel may be used for corrosion protection. It should be noted that any other hybrid composition options may exist.

The above described method may be applied to conventionally molded, formed, or incrementally sheet formed objects (e.g., plastic or fiber reinforced plastics). Deposition may not be uniform on all surfaces and, instead, the features may be selectively applied only to desired regions or to build up a specific feature for further processing.

### Joining of Aluminum and Reinforced Composite Structure via Cold Spray

The joining of aluminum and reinforced composite structures via cold spray deposition may also require other considerations including material compatibility, thermal degradation, and Galvanic corrosion. For instance, the thermoplastic or thermoset metric should not be destroyed from hot exhaust gasses. In addition, particle erosion is another consideration when depositing material to a polymer substrate via cold spray.

The embodiments describe several process flows that utilize different matrix preservation techniques. Several cold spray deposition strategies may be used to deposit an initial Titanium layer to the substrate for Galvanic corrosion control. Cold spray deposition may be used to continue buildup of a uniform metallic interface for joining. Depending on the geometry of the component to be joined, different cold spray joining deposition strategies can be used. For surface mounting, a through hole feature (e.g., machined hole 412 shown in FIG. 4D) can be used to deposit material via cold spray in and around an entire feature to “sandwich” or enclose the joint. For surface joining, cold spray deposition may be similar to butt, lap, and edge welds.

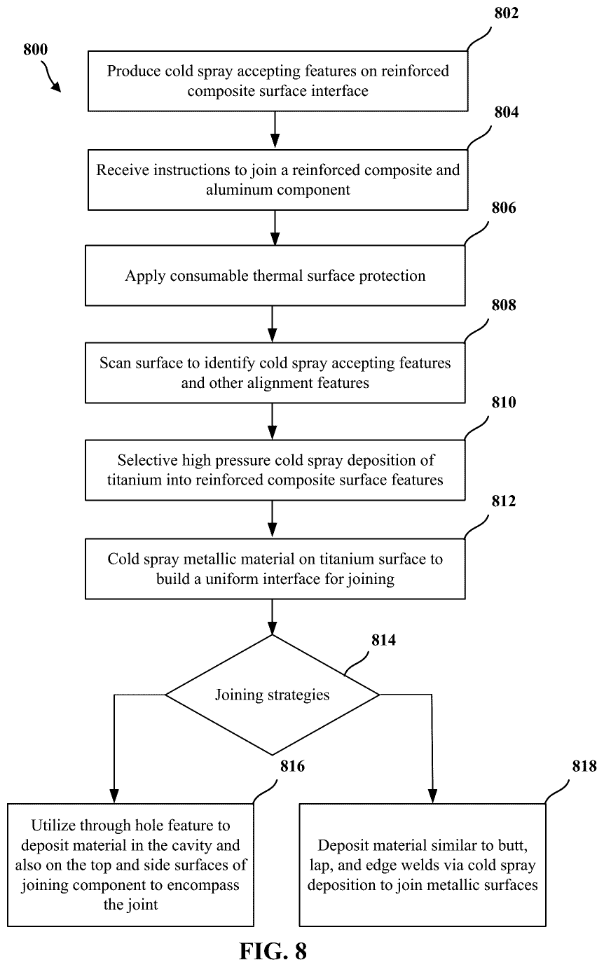

FIG. 8 illustrates a process in accordance with an aspect of the present disclosure. For example, cold spray against a carbon fiber part which has a resin matrix may degrade the surface of the carbon fiber part when cold spray is directed onto the carbon fiber. A solution may be to paint a metallic brush plating to mediate the initial load transfer and then start building up on the surface. Thus, applying an additional buffer layer may facilitate good adhesion without eroding the material.

FIG. 8 is a flowchart 800 illustrating an exemplary process for applying a consumable surface coating to protect the composite substrate during an initial layer deposition in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

The method 800 may be used for bonding to a composite with a soft material and a hard material. Specifically, the cold spray may be used as a primary bonding method to a composite surface.

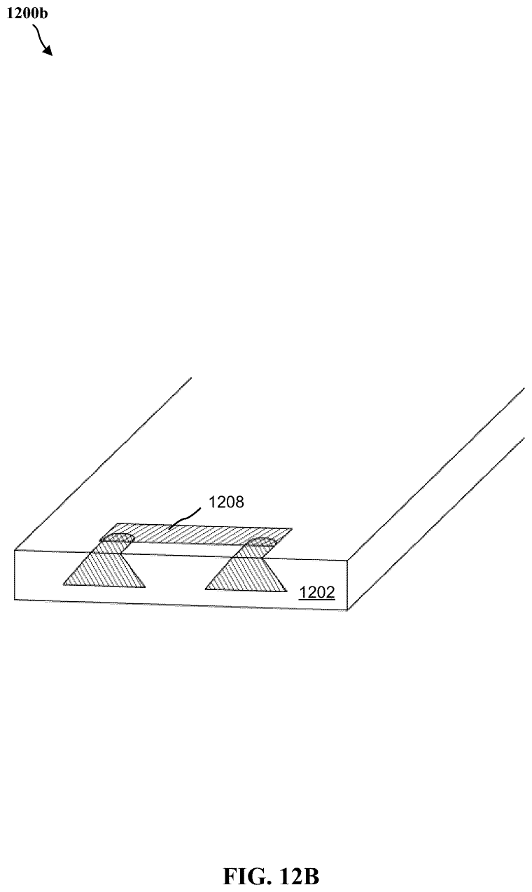

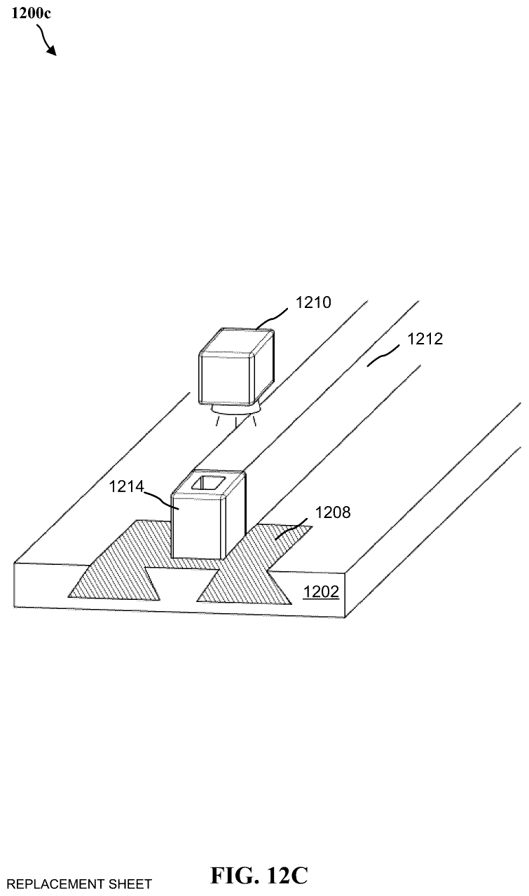

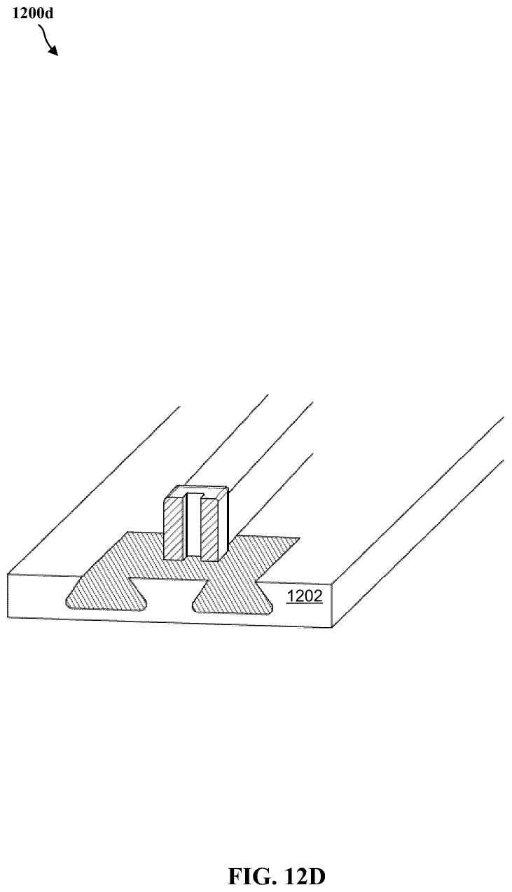

At block 802, the method 800 may include producing cold spray accepting features on reinforced composite surface interface. As will be shown in FIG. 12A, a composite substrate 1202 may be produced with a dovetail cross-section feature or cavity 1206 for accepting cold spray deposition. For example, block 802 may include operation of a 3-D printer system (e.g., PBF system 100) or another additively manufacturing system to produce a cold spray accepting feature.

At block 804, the method 800 may include receiving instructions to join a reinforced composite and aluminum component.

At block 806, the method 800 may include applying consumable thermal surface protection.

At block 808, the method 800 may include scanning the surface to identify cold spray accepting features and other alignment features. For example, the method 800 may use a metrology type scanning process to assess a geometry to be deposited on. In addition, the scan may also be used to modify a preplanned tool path to algin a path tool to the surface based on the geometry. Referring to FIG. 13, block 808 may include operation of cold spray head 1302 mount equipped with a heat source and a laser 1306 configured to scan a surface to identify cold spray accepting features and other alignment features. As another example, referring to FIG. 12A, example 1200a shows a composite substrate with a dovetail cross-section feature or cavity 1206 on a composite substrate 1202 for accepting cold spray deposition

At block 810, the method 800 may include selective high pressure cold spray deposition of titanium into reinforced composite surface features. A selective high pressure cold spray may require that a powder feeder be capable of high gas pressure. In some cases, the high-pressure systems utilize higher pressure gases and often have a dedicated gas compressor. In some cases, a low molecular weight gas (e.g., helium) is sometimes used as the accelerating gas when particles must be brought to very high velocity.

At block 812, the method 800 may include performing cold spray metallic material on the titanium surface to build a uniform interface for joining.

At block 814, the method 800 may include determining a first joining strategy.

In a first joining strategy, at block 816, the method 800 may include utilizing through hole feature to deposit material in the cavity and also on the top and side surfaces of joining component to encompass the joint. As an example, referring back to FIG. 4D, a machined hole 412 is machined into the hollow object 402.

In a second joining strategy, at block 818, the method 800 may include depositing material similar to butt, lap, and edge welds via cold spray deposition to join metallic surfaces.

In some examples, if there is a hole feature, the first joining strategy may be used, and then the second joining strategy may be applied after the first joining strategy is applied.

A benefit of this process is to provide an additional buffer surface protection.

It is understood that the method illustrated by FIG. 8 is exemplary in nature and that the steps described herein may be combined or modified to generate alternative embodiments.

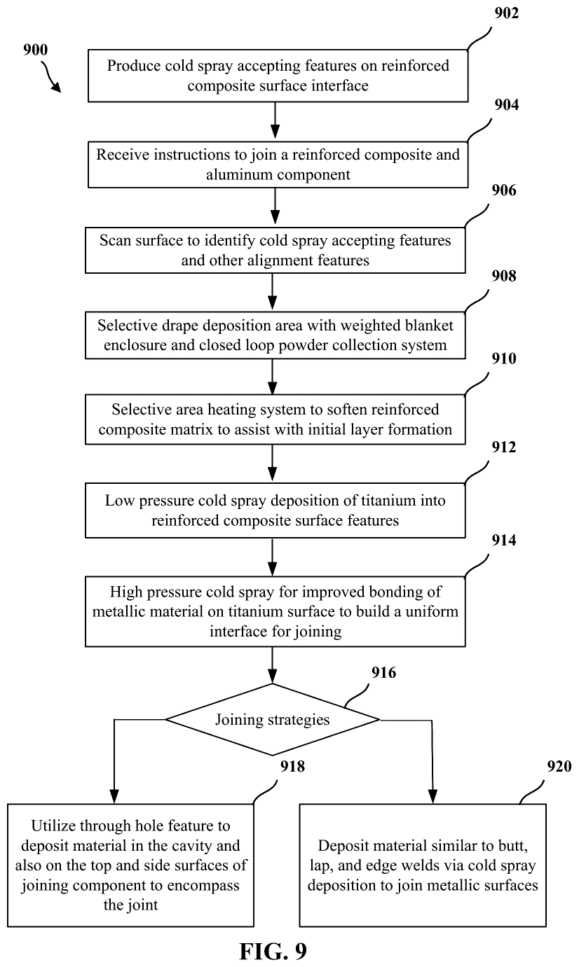

FIG. 9 illustrates a process in accordance with an aspect of the present disclosure.

FIG. 9 is a flowchart 900 illustrating an exemplary process for utilizing an area heater and carefully optimized cold spray parameters (e.g., nozzle geometry, stand-off distance, feedstock material, carrier gas temperature and pressure) on a hybrid system to soften the substrate during cold spray deposition in accordance with the systems and methods described herein. The impacting particles from the low pressure cold spray may embed themselves into the substrate rather than plastically deform to aid in the formation of the internal layers. The system can then switch to a high pressure cold spray deposition after the initial layers. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 902, the method 900 may include producing cold spray accepting features on reinforced composite surface interface. As will be shown in FIG. 12A, a composite substrate 1202 may be produced with a dovetail cross-section feature or cavity 1206 for accepting cold spray deposition. For example, block 902 may include operation of a 3-D printer system (e.g., PBF system 100) or another additively manufacturing system to produce a cold spray accepting feature.

At block 904, the method 900 may include receiving instructions to join a reinforced composite and aluminum component.

At block 906, the method 900 may include scanning surface to identify cold spray accepting features and other alignment features.

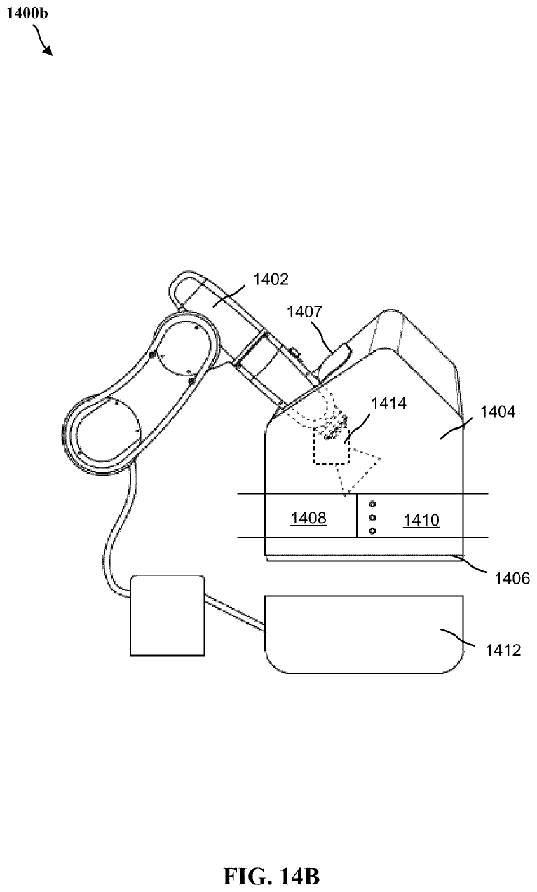

At block 908, the method 900 may include selective drape deposition area with weighted blanket enclosure and closed loop power collection system. For example, referring to FIGS. 14A and 14B, block 908 may include operation of a closed loop powder collection system with a powder blanket 1404 mounted on a robotic arm 1402 to drape the deposition area with a weighted blanket enclosure.

At block 910, the method 900 may include selective area heating system to soften reinforced composite matrix to assist with initial layer formation. For example, referring to FIG. 13, block 910 may include operation of a cold spray head mount may be equipped with a heat source 1304 configured to selectively heat and soften a matrix.

At block 912, the method 900 may include performing a low pressure cold spray deposition into reinforced composite surface features for Galvanic corrosion control. In a low pressure cold spray, the powder stream may be injected into a nozzle at a point where gas has expanded to low pressure. For example, atmospheric pressure air, drawn by the lower pressure nozzle injection point, may be used for powder transport from a powder feeder. In some examples, a low pressure cold spray may utilize compressed air or nitrogen. Referring back to FIG. 13, block 912 may include operation of a cold spray head 1302 with a heat source 1304 configured to selectively heat and soften the matrix and a laser 1306 configured to measure standoff distance measurements and control spray parameters.

At block 914, the method 900 may include performing a high pressure cold spray for improved bonding of metallic material on titanium surface to build a uniform interface for joining. Referring back to FIG. 13, block 914 may include operation of a cold spray head 1302 configured to performing a high pressure cold spray for improved bonding of metallic material on titanium surface to build a uniform interface for joining.

At block 916, the method 900 may include determining a joining strategy.

In a first joining strategy, at block 918, the method 900 may include utilizing through hole feature to deposit material in the cavity and also on the top and side surfaces of joining component to encompass the joint. As an example, referring back to FIG. 4D, a machined hole 412 is machined into the hollow object 402.

In a second joining strategy, at block 920, the method 900 may include depositing material similar to butt, lap, and edge welds via cold spray deposition to join metallic surfaces.

In some examples, if there is a hole feature, the first joining strategy may be used, and then the second joining strategy may be applied after the first joining strategy is applied.

It is understood that the method illustrated by FIG. 9 is exemplary in nature and that the steps described herein may be combined or modified to generate alternative embodiments.

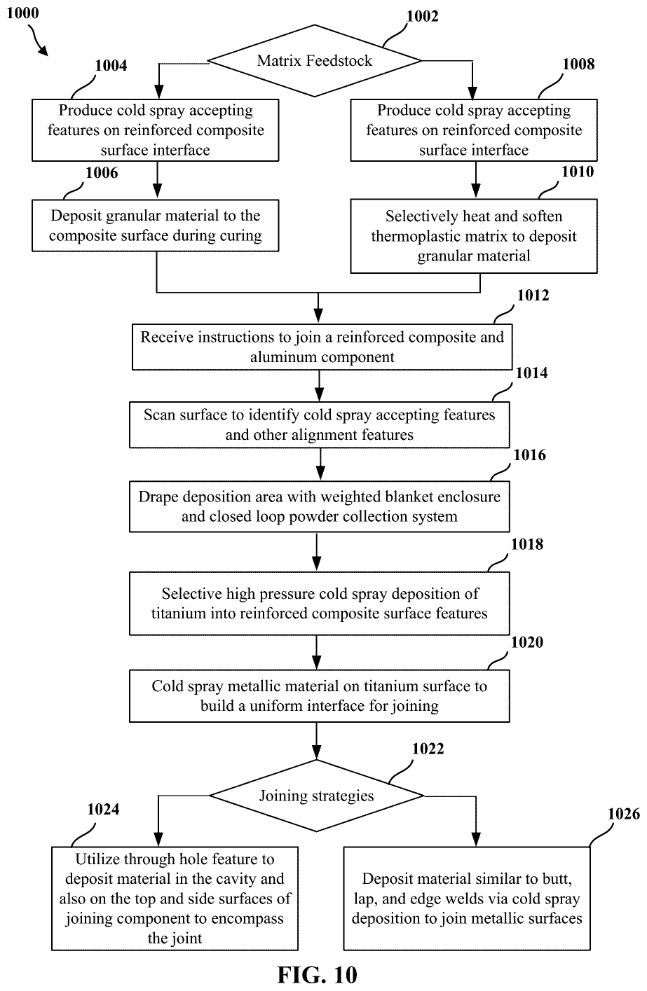

FIG. 10 illustrates a process in accordance with an aspect of the present disclosure.

The thermoplastic matrix can again be heated and softened for the deposition of the granular material prior to cold spray deposition. This granular material serves as a protective coating from thermal degradation and improves the initial layer adhesion.

FIG. 10 is a flowchart 1000 illustrating an exemplary process for depositing a granular material to the surface of the thermoset during curing in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1002, the method 1000 may include determining whether the matrix feedstock is thermoset or thermoplastic. If the matrix feedstock is thermoset, then the material may be softened. However, if the matrix feedstock is thermoplastic, then the material may not be softened and, instead, the thermoplastic may be burnt.

When the matrix feedstock is determined to be thermoset, at block 1004, the method 1000 may include producing cold spray accepting features on reinforced composite surface interface. As will be shown in FIG. 12A, a composite substrate 1202 may be produced with a dovetail cross-section feature or cavity 1206 for accepting cold spray deposition. At block 1006, the method 1000 may include depositing granular material to the composite surface during curing.

When the matrix feedstock is determined to be thermoplastic, at block 1008, the method 100 may include producing cold spray accepting features on reinforced composite surface interface. At block 1010, the method 1000 may include selectively heat and soften thermoplastic matrix to deposit granular material prior to cold spray deposition. The granular material may serve as protecting coating from thermal degradation and improve the initial layer adhesion. In some examples, the selective heating may be performed by using hot gas in the cold spray system. For example, a cold spray head mount may be equipped with a heat source 1304 configured to selectively heat and soften a thermoplastic matrix.

For example, blocks 1004 and 1008 may include operation of a 3-D printer system (e.g., PBF system 100) or another additively manufacturing system to produce a cold spray accepting feature.

At block 1012, the method 1000 may include receiving instructions to join a reinforced composite and aluminum component.

At block 1014, the method 1000 may include scanning surface to identify cold spray accepting features and other alignment features.

At block 1016, the method 1000 may include draping deposition area with weighted blanket enclosure and closed loop powder collection system. For example, referring to FIGS. 14A and 14B, block 1016 may include operation of a closed loop powder collection system with a robotic arm 1402 to drape the deposition area with a powder blanket 1404.

At block 1018, the method 1000 may include selective high pressure cold spray deposition of titanium into reinforced composite surface features for Galvanic corrosion control. For example, referring to FIG. 13, block 1018 may include operation of a cold spray head mount configured to selective high pressure cold spray deposition of titanium into reinforced composite surface features for Galvanic corrosion control.

At block 1020, the method 1000 may include cold spray metallic material on titanium surface to build a uniform interface for joining. For example, referring to FIG. 13, block 1020 may include operation of a cold spray head mount configured to cold spray metallic material on titanium surface to build a uniform interface for joining. As another example, referring to FIG. 12B, example 1200b shows an example of a composite substrate with two dovetail cross-section features/cavities for accepting cold spray deposition.

At block 1022, the method 1000 may include determining a joining strategy.

In a first joining strategy, at block 1024, the method 1000 may include utilizing a through hole feature to deposit material in the cavity and also on the top and side surfaces of joining component to encompass the joint. As an example, referring back to FIG. 4D, a machined hole 412 is machined into the hollow object 402.

In a second joining strategy, at block 1026, the method 1000 may include depositing material similar to butt, lap, and edge welds via cold spray deposition to join metallic surfaces.

In some examples, if there is a hole feature, the first joining strategy may be used, and then the second joining strategy may be applied after the first joining strategy is applied.

It is understood that the method illustrated by FIG. 10 is exemplary in nature and that the steps described herein may be combined or modified to generate alternative embodiments.

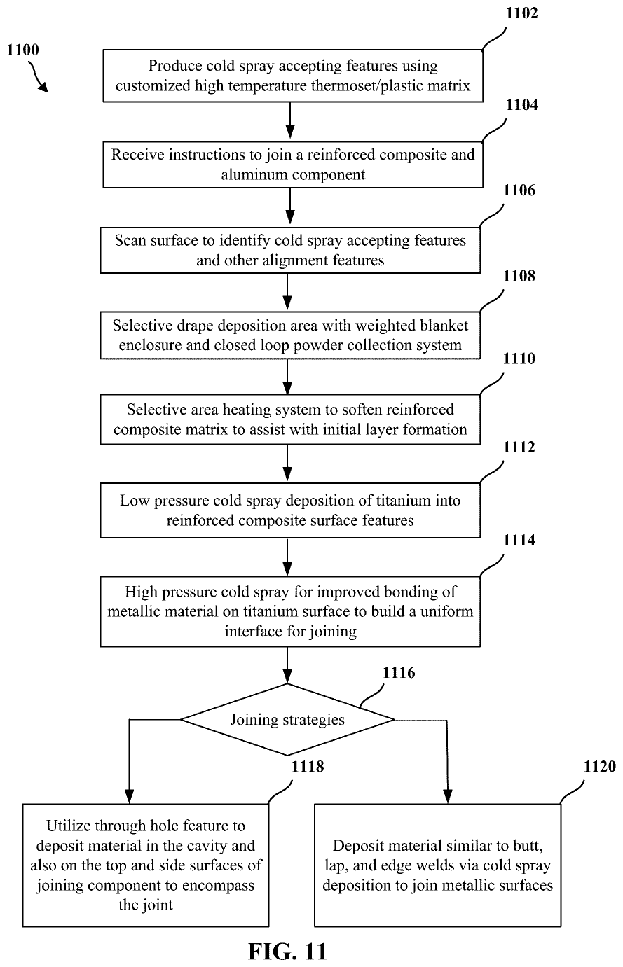

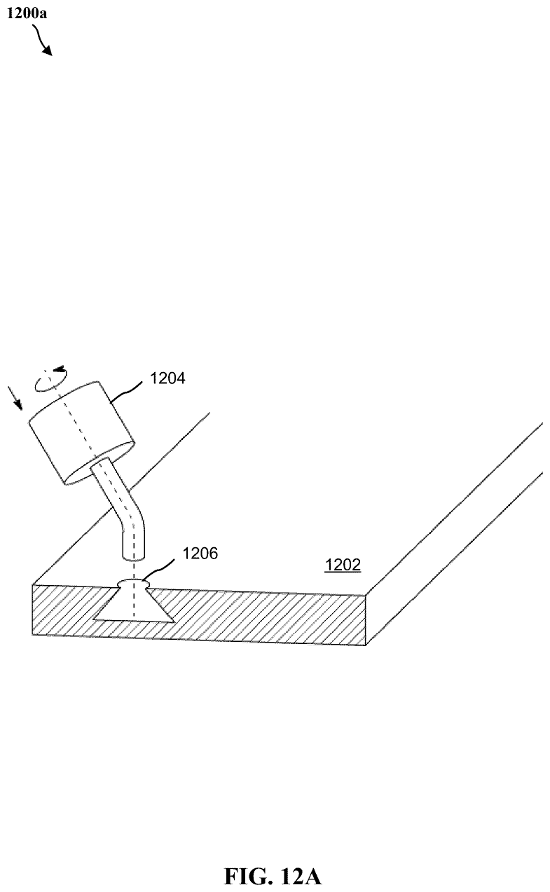

FIG. 11 illustrates a process in accordance with an aspect of the present disclosure.

FIG. 11 is a flowchart 1100 illustrating an exemplary process for utilizing high temperature thermoplastics and thermosets reinforced with Kevlar fibers in accordance with the systems and methods described herein. The improved temperature and erosion resistance allows a higher powered pulsed-gas dynamic spraying system to be employed to assist with initial layer formation. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1102, the method 1100 may include producing cold spray accepting features using customized high temperature thermoset/plastic matrix. As will be shown in FIG. 12A, a composite substrate 1202 may be produced with a dovetail cross-section feature or cavity 1206 for accepting cold spray deposition. For example, block 1102 may include operation of a 3-D printer system (e.g., PBF system 100) or another additively manufacturing system to produce a cold spray accepting feature.

At block 1104, the method 1100 may include receiving instructions to join a reinforced composite and aluminum component.

At block 1106, the method 1100 may include scanning surface to identify cold spray accepting features and other alignment features.

At block 1108, the method 1100 may include selective drape deposition with weighted blanket enclosure and closed loop powder collection system. For example, referring to FIGS. 14A and 14B, block 1108 may include operation of a closed loop powder collection system with a robotic arm 1402 to drape the deposition area with a powder blanket 1404.

At block 1110, the method 1100 may include selective area heating system to soften reinforced composite matrix to assist with initial layer formation. For example, referring to FIG. 13, block 110 may include operation of a cold spray head mount equipped with a heat source 1304 configured to selectively heat and soften a matrix.

At block 1112, the method 1100 may include low pressure cold spray deposition of titanium into reinforced composite surface features for Galvanic corrosion control. For example, referring to FIG. 13, block 1112 may include operation of a cold spray head mount configured to provide low pressure cold spray deposition of titanium.

At block 1114, the method 1100 may include high pressure cold spray for improved bonding of metallic material on titanium surface to build a uniform interface for joining. For example, referring to FIG. 13, block 1114 may include operation of a cold spray head mount configured to provide high pressure cold spray for improved bonding of metallic material on titanium surface

At block 1116, the method 1100 may include determining a joining strategy.

In a first joining strategy, at block 1118, the method 1100 may include utilizing a through hole feature to deposit material in the cavity and also on the top and side surfaces of joining component to encompass the joint.

In a second joining strategy, at block 1120, the method 1100 may include depositing material similar to butt, lap, and edge welds via cold spray deposition to join metallic surfaces.

In some examples, if there is a hole feature, the first joining strategy may be used, and then the second joining strategy may be applied after the first joining strategy is applied.

It is understood that the method illustrated by FIG. 11 is exemplary in nature and that the steps described herein may be combined or modified to generate alternative embodiments.

The reinforced composite surface may be produced with geometric features or cavities for accepting cold spray material deposition (e.g., dovetail cross section). After instructions to join the reinforced composite and aluminum components are received, an image processing system may scan the surface to identify the cold spray deposition and alignment features. Tool paths may be generated from the scanned data, and a traveling enclosure with a closed loop powder collection system may drape the anticipated deposition area.

FIGS. 12A-12D show a cross sectional cut of a cold spray composite joining overview.

FIG. 12A shows an example 1200a of a composite substrate with a cavity or feature for cold spray deposition. Specifically, example 1200a shows a cold spray head 1204 filling a dovetail cross-section feature or cavity 1206 on a composite substrate 1202 formed to accept cold spray deposition.

FIG. 12B shows an example 1200b of a composite substrate with two dovetail cross-section features/cavities for accepting cold spray deposition. Specifically, example 1200b shows a composite substrate 1202 with metallic interfaces 1208 built for joining. In some examples, the metallic interfaces 1208 may be a “land bridge” across the two metallic features that are anchored in the composite part.

FIG. 12C shows an example 1200c of performing a cold spray deposition 1210 on a substrate using a structure 1212 with a surface mount 1214.

FIG. 12D shows an example 1200d of a cold spray deposition in and around the surface mounting joint on a composite substrate 1202.

FIG. 13 shows an example of a cold spray head mount equipped with heat source and laser. Specifically, example 1300 shows a cold spray head 1302 with a heat source 1304 configured to selectively heat and soften the matrix and a laser 1306 configured to measure standoff distance measurements and control spray parameters. In some examples, the heat source 1304 may be coupled to a robotic end effector. In some examples, the laser 1306 may be a range finder. In some examples, the cold spray head 1302 may start a low pressure before ramping up to a higher pressure.

FIG. 14A shows closed loop powder collection system. Specifically, example 1400a shows a powder blanket 1404 with a weighted rim 1406 mounted on a robotic arm 1402. The powder blanket 1404 is thick and may capture overspray during the process since not all particles adhere to a surface and may bounce off the surface due to surface energy or two particles colliding at a point on the surface at the exact same time and bouncing off each other. In some examples, adhesion rates in a very good cold spray process may be 90%.

FIG. 14B shows another view of a closed loop powder collection system. Specifically example 1400b shows a version of the closed loop powder collection system where the contents inside the powder blanket 1404 are revealed as dotted lines in order to see the components under the powder blanket 1404.

FIG. 14B shows a cold spray head 1414 configured to perform cold spray on a first structure 1408 and second structure 1410 to join them together. Here, the powder blanker 1404 has a flap 1407 to insert the robotic arm 1402 with the cold spray head 1414. In some examples, the power blanket 1404 may help collect material and catch any material during the cold spray process in a recollection tub 1412.

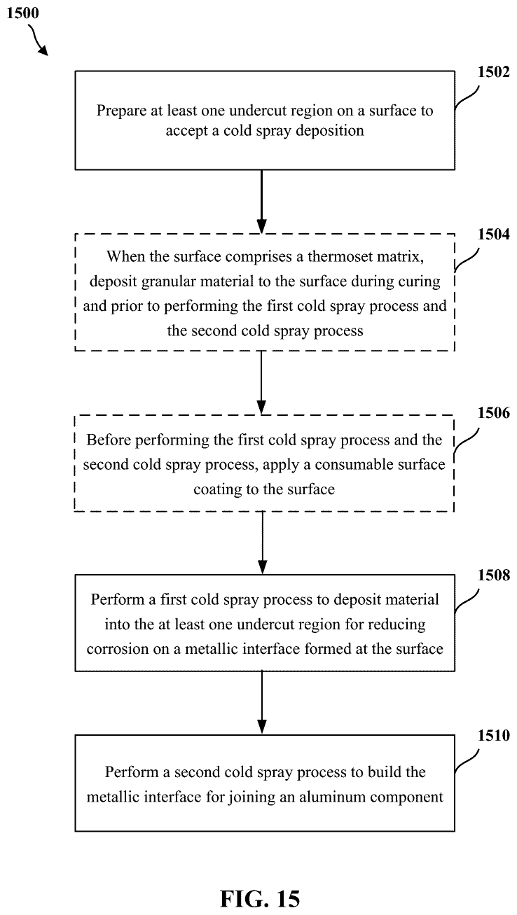

FIG. 15 illustrates a process in accordance with an aspect of the present disclosure.

FIG. 15 is a flowchart 1500 illustrating an exemplary process applying cold spray deposition in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1502, the method 1500 may include preparing at least one undercut region on a surface to accept a cold spray. Referring back to FIG. 12A, a dovetail cross-section feature or cavity may be prepared on a composite substrate 1202 to accept a cold spray.

Optionally, at block 1504, the method 1500 may include, when the surface comprises a thermoset matrix, depositing granular material to the surface during curing and prior to performing the first cold spray process and the second cold spray process. In some examples, the first cold spray process may include applying a first pressure to soften the surface and the second cold spray process may include a second pressure, where the first pressure is lower than the second pressure.

Optionally, at block 1506, the method 1500 may include, before performing the first cold spray process and the second cold spray process, applying a consumable surface coating to the surface.

At block 1508, the method 1500 may include performing a first cold spray process to deposit material into the at least one undercut region for reducing corrosion on a metallic interface formed at the surface. Referring back to FIG. 12A, the example 1200a shows a cold spray head 1204 depositing material into a dovetail feature or cavity 1206 on a composite substrate.

At block 1510, the method 1500 may include performing a second cold spray process to build the metallic interface for joining an aluminum component. Referring back to FIG. 12B, the example 1200b shows a composite substrate 1202 with metallic interfaces 1208 built for joining an aluminum component.

In some examples, the first cold spray process may include applying a first pressure to soften the surface and the second cold spray process may include a second pressure, where the first pressure is lower than the second pressure.

In some examples, the first cold spray process may include applying a first temperature to soften the surface and the second cold spray process may include a second temperature, where the first temperature is higher than the second temperature. Referring back to FIG. 13, a cold spray head 1302 equipped with a heat source 1304 may be configured to selectively heat and soften the surface.

It is understood that the method illustrated by FIG. 15 is exemplary in nature and that the steps described herein may be combined or modified to generate alternative embodiments.

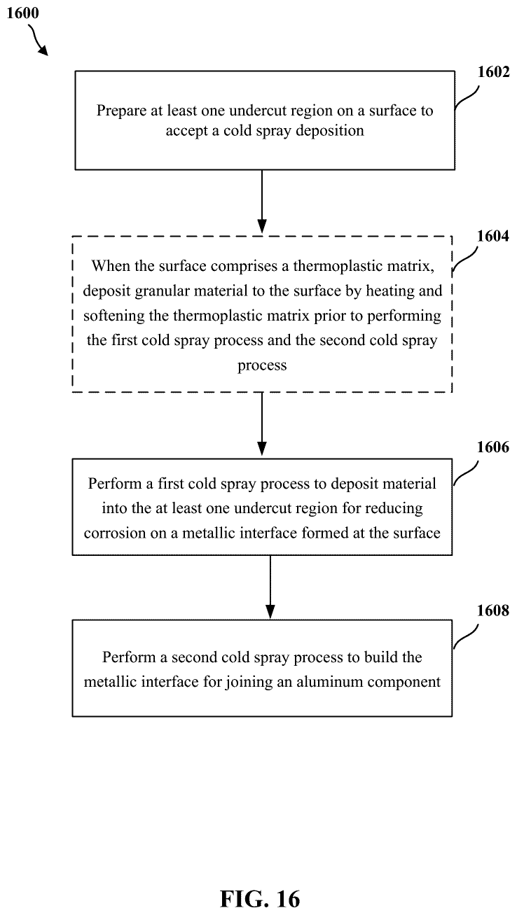

FIG. 16 illustrates a process in accordance with an aspect of the present disclosure.

FIG. 16 is a flowchart 1600 illustrating an exemplary process applying cold spray deposition in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1602, the method 1600 may include preparing at least one undercut region on a surface to accept a cold spray.

Optionally, at block 1604, the method 1600 may include, when the surface comprises a thermoplastic matrix, depositing granular material to the surface by heating and softening the thermoplastic matrix prior to performing the first cold spray process and the second cold spray process. In some examples, the thermoplastic matrix is heated using a cold spray system. Referring back to FIG. 13, the example 1300 shows a cold spray head 1302 mounted equipped with a heat source 1304 configured to selectively heat and soften the thermoplastic matrix.

At block 1606, the method 1600 may include performing a first cold spray process to deposit material into the at least one undercut region for reducing corrosion on a metallic interface formed at the surface.

At block 1608, the method 1600 may include performing a second cold spray process to build the metallic interface for joining an aluminum component.

It is understood that the method illustrated by FIG. 16 is exemplary in nature and that the steps described herein may be combined or modified to generate alternative embodiments.

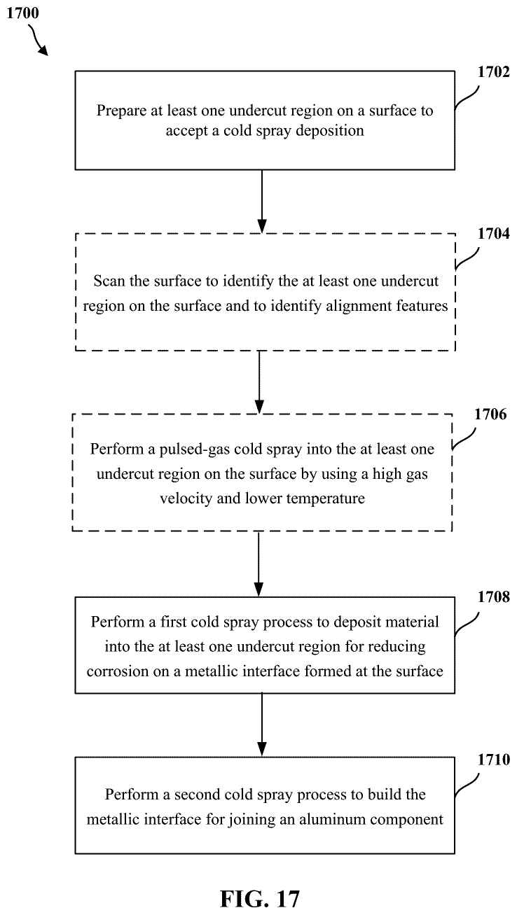

FIG. 17 illustrates a process in accordance with an aspect of the present disclosure.

FIG. 17 is a flowchart 1700 illustrating an exemplary process applying cold spray deposition in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1702, the method 1700 may include preparing at least one undercut region on a surface to accept a cold spray deposition. In some examples, the at least one undercut region may include a dovetail cross-section feature.

Optionally, at block 1704, the method 1700 may include scanning the surface to identify the at least one undercut region on the surface and to identify alignment features. Referring to FIG. 13, block 1704 may include operation of cold spray head 1302 mount equipped with a heat source and a laser 1306 configured to scan a surface to identify cold spray accepting features and other alignment features. As another example, referring to FIG. 12A, example 1200a shows a composite substrate with a dovetail cross-section feature or cavity 1206 on a composite substrate 1202 for accepting cold spray deposition

Optionally, at block 1706, the method 1700 may include performing a pulsed-gas cold spray into the at least one undercut region on the surface by using a high gas velocity and lower temperature. Referring back to FIG. 12D, example 1300 shows a cold spray head 1302 with a heat source 1304 configured to selectively heat and soften the matrix and a laser 1306 configured to measure standoff distance measurements and control spray parameters. Referring back to FIG. 17, example 1300 shows a cold spray head 1302 with a heat source 1304 configured to selectively heat and soften the matrix and a laser 1306 configured to measure standoff distance measurements and control spray parameters. In some examples, the cold spray head 1302 may start a low pressure before ramping up to a higher pressure.

At block 1708, the method 1700 may include performing a cold spray to deposit material into the at least one undercut region for reducing corrosion on a metallic interface formed at the surface.

At block 1710, the method 1700 may include performing a second cold spray process to build the metallic interface for joining an aluminum component.

It is understood that the method illustrated by FIG. 17 is exemplary in nature and that the steps described herein may be combined or modified to generate alternative embodiments.

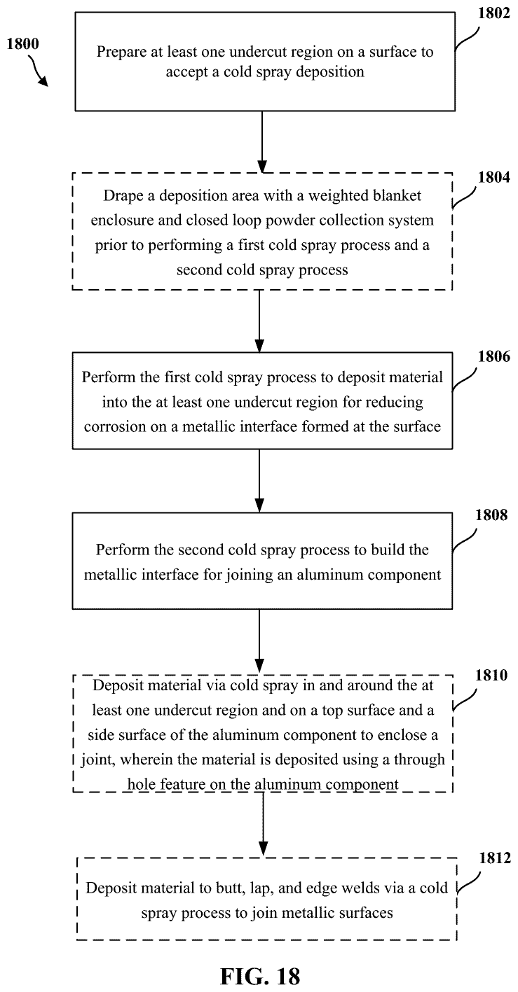

FIG. 18 illustrates a process in accordance with an aspect of the present disclosure.

FIG. 18 is a flowchart 1800 illustrating an exemplary process applying cold spray deposition in accordance with the systems and methods described herein. Optional aspects are illustrated in dashed lines. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 1802, the method 1800 may include preparing at least one undercut region on a surface to accept a cold spray deposition.

Optionally, at block 1804, the method 1800 may include draping a deposition area with a weighted blanket enclosure and closed loop powder collection system prior to performing a first cold spray process and a second col spray process. Referring back to FIG. 14B, example 1400b shows a closed loop powder collection system where the contents inside the powder blanket 1404 (usually not shown) are revealed as dotted lines in order to see the components under the powder blanket 1404.

At block 1806, the method 1800 may include performing the first cold spray process to deposit material into the at least one undercut region for reducing corrosion on a metallic interface formed at the surface.

At block 1808, the method 1800 may include performing the second cold spray process to build the metallic interface for joining an aluminum component.

Optionally, at block 1810, the method 1800 may include depositing material via cold spray in and around the at least one undercut region and on a top surface and a side surface of the aluminum component to enclose a join, wherein the material is deposited using a through hole feature on the aluminum component. Referring back to FIG. 12C, the example 1200c shows a composite substrate with a cold spray deposition 1210 using a structure 1212 with a surface mount 1214.

Optionally, at block 1812, the method 1800 may include depositing material to butt, lap, and edge welds via a cold spray process to join metallic surfaces.

It is understood that the method illustrated by FIG. 18 is exemplary in nature and that the steps described herein may be combined or modified to generate alternative embodiments.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing and joining nodes and subcomponents. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), or analogous law in applicable jurisdictions, unless the element is expressly recited using the phrase “means for” or, in the case of a method claim, the element is recited using the phrase “step for.”

What is claimed is:

1. An apparatus, comprising:
an additively manufactured hollow node having a surface opening; and
adhesive material extending from the surface opening into an internal volume of the additively manufactured hollow node.

2. The apparatus of claim 1, wherein the adhesive material comprises a foaming adhesive.

3. The apparatus of claim 1, wherein the adhesive material comprises a non-foaming adhesive.

4. The apparatus of claim 1, wherein the additively manufactured hollow node comprises a printed distribution system matrix having at least an internal channel and a port to spatially distribute the adhesive material.

5. The apparatus of claim 4, wherein the internal channel and the port are filled with the adhesive material to segment the internal volume of the additively manufactured hollow node.

6. The apparatus of claim 1, further comprising:
an embedded part coupled to an internal surface of the additively manufactured hollow node with the adhesive material.

7. The apparatus of claim 6, wherein the embedded part corresponds to a measurement device.

8. The apparatus of claim 1, further comprising:
an additional additively manufactured part coupled to an outer surface of the additively manufactured hollow node via the adhesive material and a tongue and groove connection.

9. The apparatus of claim 8, wherein the adhesive material is continuous with the outer surface of the additively manufactured hollow node.

10. The apparatus of claim 8, where the adhesive material extends past the surface opening of the additively manufactured hollow node.

11. The apparatus of claim 8, wherein the adhesive material comprises a foaming adhesive.

12. The apparatus of claim 8, wherein the adhesive material comprises a non-foaming adhesive.

13. The apparatus of claim 1, further comprising:
a support structure for further processing to be carried out in the internal volume.

14. The apparatus of claim 13, wherein the support structure comprises a cold spray material.

15. The apparatus of claim 14, wherein the cold spray material comprises a ductile aluminum alloy on an outer surface of the additively manufactured hollow node to create a metallic surface.

16. A method comprising:
printing a hollow node having a surface opening by additive manufacturing; and
injecting adhesive material into an internal volume of the hollow node via the surface opening.

17. The method of claim 16, comprising:
removing trapped materials from the hollow node through the surface opening.

18. The method of claim 16, wherein the adhesive material comprises a foaming adhesive.

19. The method of claim 16, wherein the adhesive material comprises a non-foaming adhesive.

20. The method of claim 16, wherein the hollow node comprises a printed distributed system matrix comprising at least an internal channel and a port to spatially distribute the adhesive material.

21. The method of claim 20, wherein the internal channel and the port are filled with the adhesive material to segment internal volumes of the hollow node.

22. The method of claim 16, further comprising:
coupling an embedded part to an inner surface of hollow node with the adhesive material.

23. The method of claim 16, further comprising:
coupling an additional additively manufactured part to an outer surface of the hollow node via the adhesive material and a tongue and groove connection.

24. The method of claim 23, wherein the adhesive material is continuous with the outer surface of the hollow node.

25. The method of claim 23, wherein the adhesive material extends past the surface opening of the hollow node.

26. The method of claim 23, wherein the adhesive material comprises a foaming adhesive.

27. The method of claim 23, wherein the adhesive material comprises a non-foaming adhesive.

28. The method of claim 16, further comprising:
forming a support structure for further processing to be carried out in the internal volume.

29. The method of claim 28, wherein the support structure comprises a cold spray material.

30. The method of claim 29. wherein the cold spray material comprises a ductile aluminum alloy on an outer surface of the hollow node to create a metallic surface.

31. The method of claim 16, further comprising:
shaping a surface layer proximate to the surface opening of the hollow node comprises using a foaming adhesive as the adhesive material in the surface opening.

32. The method of claim 16, further comprising:
applying heat to a sealant; and
causing the sealant to expand around an additional additively manufactured part and the surface opening of the hollow node to seal the adhesive material in the surface opening.

33. A method comprising:
preparing at least one undercut region on a surface to accept a cold spray deposition:
performing a first cold spray process to deposit material into the at least one undercut region for reducing corrosion on a metallic interface formed at the surface; and
performing a second cold spray process to build the metallic interface for joining an aluminum component.

34. The method of claim 33. further comprising:
before performing the first cold spray process and the second cold spray process. applying a consumable surface coating to the surface.

35. The method of claim 33, wherein the first cold spray process comprises applying a first pressure to soften the surface and the second cold spray process comprises a second pressure, wherein the first pressure is lower than the second pressure.

36. The method of claim 33, wherein the first cold spray process comprises applying a first temperature to soften the surface and the second cold spray process comprises a second temperature, wherein the first temperature is higher than the second temperature.

37. The method of claim 33, further comprising:
when the surface comprises a thermoset matrix, depositing granular material to the surface during curing and prior to performing the first cold spray process and the second cold spray process.

38. The method of claim 37. wherein the first cold spray process comprises applying a first pressure to soften the surface and the second cold spray process comprises a second pressure, wherein the first pressure is lower than the second pressure.

39. The method of claim 33. further comprising:
when the surface comprises a thermoplastic matrix, depositing granular material to the surface by heating and softening the thermoplastic matrix prior to performing the first cold spray process and the second cold spray process.

40. The method of claim 39, wherein the thermoplastic matrix is heated using a cold spray system.

41. The method of claim 33. further comprising:
performing a pulsed-gas cold spray into the at least one undercut region on the surface by using a high gas velocity and lower temperature.

42. The method of claim 33. wherein the at least one undercut region comprises a dovetail cross-section feature.

43. The method of claim 33. further comprising:
scanning the surface to identify the at least one undercut region on the surface and to identify alignment features.

44. The method of claim 33. further comprising:
depositing material via cold spray in and around the at least one undercut region and on a top surface and a side surface of the aluminum component to enclose a joint, wherein the material is deposited using a through hole feature on the aluminum component.

45. The method of claim 44, further comprising:
depositing material to butt. lap, and edge welds via a cold spray process to join metallic surfaces.

46. The method of claim 33. further comprising:
draping a deposition area with a weighted blanket enclosure and closed loop powder collection system prior to performing the first cold spray process and the second cold spray process.
